(19) United States
(12) Patent Application Publication
(10) Pub. No.: US 2010/0297327 A1
(43) Pub. Date: Nov. 25, 2010

(54) METHOD, SYSTEM AND COMBINATION FOR DELIVERING SWEETENERS FOR CONSUMER USE

(76) Inventor: Donavon Stangle, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/751,229

(22) Filed: Mar. 31, 2010

Related U.S. Application Data
(60) Provisional application No. 61/180,034, filed on May 20, 2009.

(51) Int. Cl. A23L 2/60; B67D 7/76

(52) U.S. Cl. 426/564; 222/190

(57) ABSTRACT

A system for delivering sweeteners comprising a sweetener solution of at least a stevia-based foam inducing solute and a solvent combined with a dispenser configured to dispense the sweetener solution as a lasting foam. The sweetener solution may further include sugar or a sugar substitute dissolved therein. A method for delivering sweeteners for consumer use is also provided.

### BACKGROUND

1. Technical Field

This disclosure is generally related to artificial and natural sweeteners and methods and means for delivering the same, and more particularly to sweeteners dispensed as a lasting foam.

2. Description of the Related Art

Artificial and natural sweeteners provide means for sweetening a variety of consumable products, such as, for example, coffee, tea, fruit and cereal. Known sweeteners include common table sugar (i.e., sucrose), various artificial sweeteners (e.g., saccharin, aspartame and sucralose) and natural sweeteners (e.g., stevia extracts).

Also known are means for delivering or dispensing such sweeteners. For example, packets of dry sweeteners are commonly found in restaurants and the like for selectively adding sweetener to coffee and other consumable products by sprinkling the contents of the packets over such products. These packets generally come in a single serving size and provide means of selectively sweetening products to taste by adjusting the number of packets used. These packets present an inefficient and cumbersome process of delivering sweeteners when using multiple packets. In addition, because the packets are not adapted for subsequent use, a portion of the contents of a packet is often discarded when a consumer is desirous of less than a full packet, thus leading to unnecessary waste. Furthermore, packets must be discarded or recycled after use and are not particularly environmentally friendly.

As another example, sweeteners have been developed for application in liquid droplet form. Liquid sweeteners are generally stored in a container having a screw-on eyedropper type lid, which requires a consumer to hold the container with one hand, unscrew the eyedropper with the other, and then squeeze the eyedropper to apply drops of sweetener to consumable products. When used in connection with solid consumables, this method of application is particularly inefficient resulting in only localized areas of sweetness. In addition, when using liquid drops, it is difficult to adequately cover a large area, such as, for example, the surface of cereal in a bowl. Furthermore, liquid droplets are generally highly concentrated which makes it difficult to precisely apply the drops to create a desired sweetness level.

Accordingly, improved methods and systems for storing and delivering artificial and natural sweeteners are desirable.

### BRIEF SUMMARY

A system for selectively applying sweeteners in a controlled manner to consumable goods is highly desirable. The system should be relatively inexpensive and easy-to-use and should allow for controlled application of the sweetener to a wide range of consumable products.

Various embodiments of a system and combination for selectively delivering sweeteners in a controlled manner comprises a sweetener solution of at least a stevia-based foam inducing solute and a solvent combined with a dispenser configured to dispense the sweetener solution as a lasting foam. The sweetener solution may further include sugar dissolved therein or may include a sugar substitute, such as, for example, saccharin, aspartame, sucralose or mixtures thereof.

A method for delivering sweeteners for consumer use includes storing a sweetener solution containing at least a stevia-based foam inducing solute dissolved therein in a pump-foamer and actuating the pump-foamer to dispense the sweetener solution as a lasting foam. Storing the sweetener solution containing at least a stevia-based foam inducing solute dissolved therein in a pump-foamer may include storing a sweetener solution containing at least a stevia-based foam inducing solute and a sugar substitute or sugar dissolved therein.

Further objects and advantages of the methods, systems and combinations for delivering sweeteners taught herein will become clear by studying the disclosure, drawings and claims.

### BRIEF DESCRIPTION OF THE SEVERAL VIEWS OF THE DRAWINGS

FIG. 1 is an image of a system or combination for delivering sweeteners, according to one embodiment.

FIG. 2 is an image of the system or combination of FIG. 1 shown applying sweetener to a consumable product as a lasting foam.

FIG. 3 is another image of the system or combination of FIG. 1 shown applying sweetener to a consumable product as a lasting foam.

### DETAILED DESCRIPTION

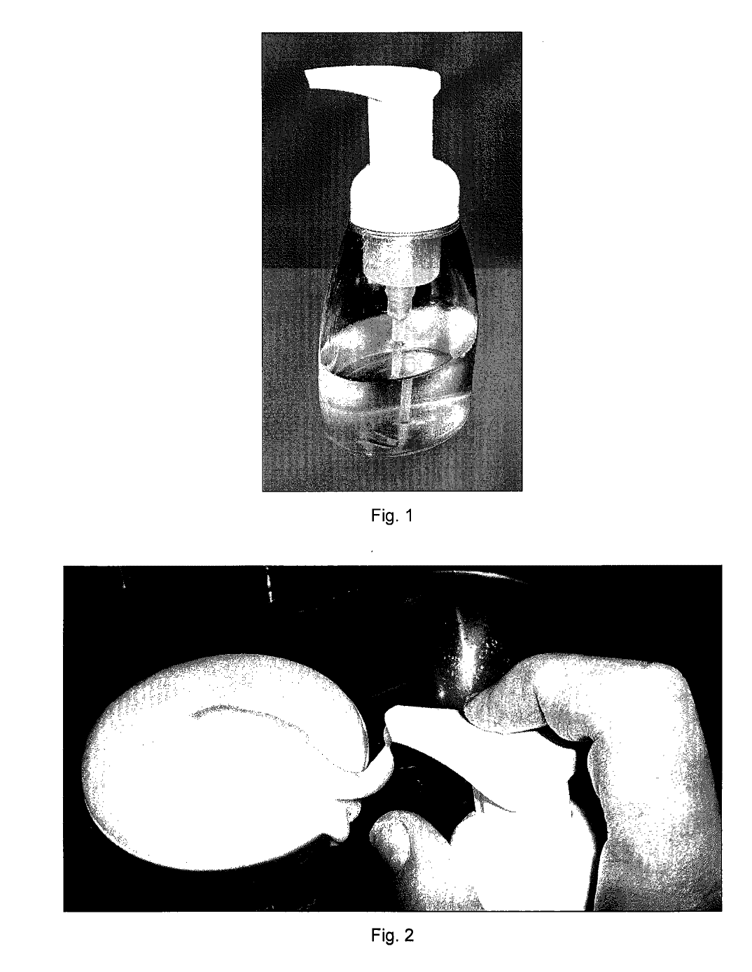

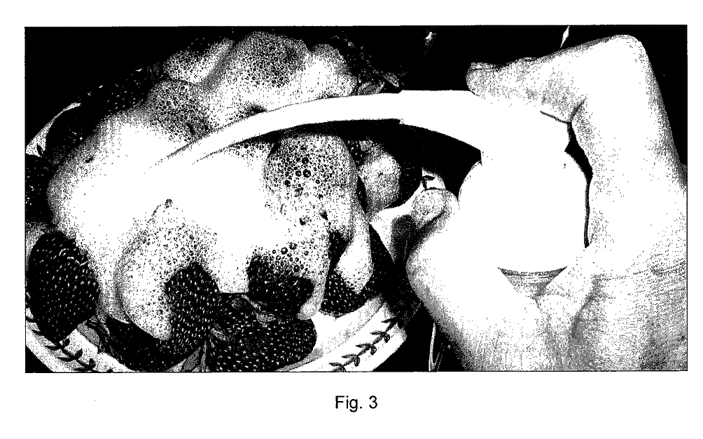

FIGS. 1 through 3 illustrate one embodiment of a system or combination for delivering sweetener for consumer use, the system or combination including a sweetener solution of at least a stevia-based foam inducing solute and a solvent (e.g., water) received within a dispenser configured to dispense the sweetener solution as a lasting foam.

The illustrated embodiment uses a dispenser in the form of a pump-foamer mechanism coupled to a bottle (collectively referred to as a “pump-foamer”), such as, for example, Item No. SET-2321 available from The E.J. McKernan Company of Reno, Nev. The pump-foamer uses a non-aerosol mechanical pumping mechanism to draw a sweetener solution from the bottle and mix the solution with air to form a lasting foam when the solution is of an acceptable formulation as described below. The non-aerosol nature of the pump-foamer means that no chemical propellants are used to dispense the solution. Other benefits of the pump-foamer include precise mixing of the sweetener solution and air to create a high quality foam. In addition, an assortment of different sized dispensers may be used for various applications, such as, for example, a small dispenser for personal use or a larger dispenser for use in restaurants. Using a pump-foamer also allows a user to accurately control the amount of sweetener that is dispensed, thus enabling users to selectively sweeten consumable products to individual tastes.

In order to enable the system to produce a lasting foam, it is necessary to use a sweetener solution of an acceptable formulation. In particular, a foam inducing solute is dissolved in a solvent in varying concentrations to produce foams of varying tastes and foam densities. Although it is contemplated that various foam inducing solutes may be used, it is preferred that the foam inducing solute be a stevia-based solute. Stevia-based means that a significant ingredient of the solute is derived from the plant Stevia Rebaudiana Bertoni (commonly called stevia), such as, for example, Truvia™ brand sweeteners marketed by Cargill, Inc., PureVia™ brand sweeteners marketed by Whole Earth Sweetener Company LLC, and NuStevia™ brand sweeteners marketed by NuNaturals, Inc. Stevia-based solutes are particularly suited for use as a foam inducing solute because such solutes assist in generating a lasting foam while simultaneously providing means for sweetening various consumable products in a natural, non-caloric manner. The amount of the stevia-based foam inducing solute may be varied to produce a resulting solution having varying concentrations characterized by different foaming capabilities and sweetness levels.

For example, in one embodiment, one-eighth of a teaspoon of a stevia-based powder, such as, for example, NuStevia™ brand stevia extract (stevia rebaudiana) distributed by NuNaturals, Inc., is dissolved in one cup of water (8 fl. oz.) to produce a resulting solution capable of developing a relatively thin lasting foam and very mild sweetness when dispensed from a pump-foamer into a cup of water. In another embodiment, one-quarter of a teaspoon of the stevia-based powder is dissolved in one cup of water to produce a resulting solution capable of developing a relatively thin lasting foam and mild sweetness. In another embodiment, one-half of a teaspoon of the stevia-based powder is dissolved in one cup of water to produce a resulting solution capable of developing a fairly thick lasting foam and fairly mild sweetness. In yet another embodiment, one teaspoon of the stevia-based powder is dissolved in one cup of water to produce a resulting solution capable of developing a thick lasting foam and moderate sweetness. This embodiment is particularly well-suited for applications wherein relatively more foam is desired to sweeten a consumable product to reasonable tastes. In still yet another embodiment, two teaspoons of the stevia-based powder is dissolved in one cup of water to produce a resulting solution capable of developing a thick lasting foam and moderate sweetness. In another embodiment, eight teaspoons of the stevia-based powder is dissolved in one cup of water to produce a resulting solution capable of developing a very thick and very sweet lasting foam when dispensed from a pump-foamer into a cup of water. This embodiment is particularly well-suited for applications wherein relatively less foam is desired to sweeten a consumable product to reasonable tastes.

It is contemplated that the amount of stevia-based foam inducing solute may vary with respect to individual tastes and with respect to a desired serving size of the dispensed foam. However, a minimum concentration of about 0.07 mass-volume percentage (% m/v) (i.e., 0.07 grams of solute per 100 mL total volume of resulting solution) of a stevia-based foam inducing agent containing stevia extract (stevia rebaudiana) is needed to produce a resulting solution capable of developing a relatively thin lasting foam. A lasting foam means a foam lasting at least 30 seconds before dissipating.

In other embodiments, wherein the stevia-based solute does not include stevia as a primary ingredient, a higher concentration of the stevia-based solute may be needed to develop a lasting foam. For example, Truvia™ brand sweeteners marketed by Cargill, Inc include erythritol, a natural sugar alcohol, which may necessitate a higher concentration of the stevia-based solute.

In one embodiment, forty packets (3.5 g per packet) of Truvia™ brand sweetener powder are dissolved at an elevated temperature in about 2 ounces of water, is settled out and then screened or filtered to remove undissolved residue and produce a resulting solution capable of developing a lasting foam and moderate sweetness when dispensed from a pump-foamer into a cup of water. In another embodiment, eighty packets of Truvia™ brand sweetener powder is dissolved in about 45 ounces of water to produce a resulting solution capable of developing a lasting foam and mild sweetness when dispensed from a pump-foamer into a cup of water.

In some embodiments, a sugar substitute may be used in combination with the stevia-based foam inducing agent and the solvent to produce the resulting sweetener solution. Sugar substitutes are well known and include, for example, artificial sweeteners such as Equal® brand sweeteners (containing aspartame as the sweetening ingredient) marketed by Merisant Company, Splenda® brand sweeteners (containing sucralose as the sweetening ingredient) marketed by McNeil Nutritionals, LLC and Sweet'N Low® brand sweeteners (containing saccharin as the sweetening ingredient) marketed by Cumberland Packing Corp.

For example, in one embodiment, one teaspoon of a stevia-based foam inducing agent containing stevia extract (stevia rebaudiana) and forty tablespoons of Splenda® sweetening powder (a sucralose-based sweetener) may be dissolved in one cup of hot water to produce a solution capable of developing a thick lasting foam sufficient to sweeten, for example, a large tea beverage with a single pump from the dispenser. In such an embodiment, the solution becomes saturated at room temperature prior to introduction of the forty tablespoons of Splenda®, and therefore, the addition of heat is required to form a supersaturated solution in which the forty tablespoons is dissolved. In another embodiment, ten tablespoons of Splenda® sweetening powder may be dissolved with one-half of a teaspoon of the stevia-based foam inducing agent in one cup of water at room temperature to produce a solution capable of developing a lasting foam adequate to lightly sweeten a cup of water with two pumps from the dispenser. In yet another embodiment, ten tablespoons of a Splenda® cooking mixture (containing no dextrose) may be dissolved with one-eighth of a teaspoon of the stevia-based foam inducing agent in one cup of water at room temperature to produce a solution capable of developing a lasting foam sufficient to lightly sweeten a cup of water with two pumps from the dispenser.

Similar results may be obtained by mixing the stevia-based foam inducing agent containing stevia extract (stevia rebaudiana) with a sugar substitute in the form of Equal® brand sweeteners (aspartame-based sweeteners). For example, 10 tablespoons of Equal® sweetening powder (containing dextrose with maltodextrin and aspartame) may be dissolved with one-quarter of a teaspoon of the stevia-based foam inducing agent in one cup of water at room temperature to produce a solution capable of developing a lasting foam adequate to lightly sweeten a cup of water with two pumps from the dispenser. The sweetness level can be adjusted by adding incremental amounts of the Equal® sweetening powder and/or the stevia-based foam inducing agent. As another example, two-hundred Equal® Tablets (containing lactose (from milk), aspartame, acesulfame potassium, cellulose gum, leucine) may be dissolved with one-eighth of a teaspoon of the stevia-based foam inducing agent in six ounces of water at an elevated temperature to produce a solution capable of developing a thick lasting foam sufficient to sweeten a cup of water with one or two pumps from the dispenser. In embodiments containing a sugar substitute in the form of Equal® Tablets, it is appreciated that a sweetener solution may be produced without the stevia-based foaming agent, however, the addition of the stevia-based foaming agent assists in generating a thicker, longer-lasting foam.

The stevia-based foam inducing agent may similarly be mixed with a sugar substitute in the form of Sweet'n Low® brand sweeteners (saccharin-based sweeteners). For example, in some embodiments, one cup of a resulting solution obtained from dissolving five-hundred Sweet'N Low® Tablets in two cups (16 fl. oz.) of water may be mixed with incremental amounts of the stevia-based foam inducing agent to produce a solution capable of developing a lasting foam—one teaspoon of the stevia-based foam inducing agent producing a solution capable of developing a very thick foam sufficient to sweeten consumable products to reasonable tastes with one or two pumps from the dispenser. In other embodiments, incremental amounts of the stevia-based foam inducing agent may be added to Sweet'N Low® Liquid (containing water, calcium saccharin, benzoic acid and methyl paraben) to produce a solution capable of developing a lasting foam—three-eighths of a teaspoon of the stevia-based foam inducing agent producing a solution capable of developing a very thick foam sufficient to sweeten consumable products to reasonable tastes with one or two pumps from the dispenser.

In other embodiments, sugar products in various forms, such as, for example, granulated cane sugar or powdered sugar, may be used in combination with the stevia-based foam inducing agent and the solvent to produce the resulting sweetener solution. For example, in one embodiment, nine tablespoons of granulated cane sugar may be dissolved in a cup of water with one-quarter of a teaspoon of the stevia-based foam inducing agent containing stevia extract (stevia rebaudiana) to produce a sweetener solution capable of developing a lasting foam adequate to lightly sweeten a cup of water with several pumps from the dispenser. A stronger solution may be produced by the incremental addition of more sugar and/or stevia-based foaming agent. In another embodiment, two cups of powdered sugar may be dissolved (at an elevated temperature) with two teaspoons of the stevia-based foam inducing agent in one cup of water to produce a solution capable of generating a very sweet and long-lasting foam. Variations in foam density and sweetness may be made by varying the amount of sugar and/or the amount of the stevia-based foam inducing agent. For example, using one teaspoon of the stevia-based foam inducing agent with two cups of sugar in a cup of water will produce a sweetener solution having relatively less sweetness than when using two teaspoons of the stevia-based foam inducing agent as described above.

In various other embodiments, the resulting sweetener solution may include other food additives dissolved therein, such as, for example, bulking agents, flavors and preservatives. These additives may be added as independent ingredients during formation of the solution or may form a sub-ingredient of the stevia-based foam inducing agent, sugar product, and/or sugar substitute.

A method for delivering sweeteners for consumer use includes storing a sweetener solution containing at least a stevia-based foam inducing solute dissolved therein in a pump-foamer, such as, for example, the pump-foamer identified as Item No. SET-2321 available from The E.J. McKernan Company of Reno, Nev. Stevia-based means that a significant ingredient of the solute is derived from the plant Stevia Rebaudiana Bertoni (commonly called stevia), such as for example, Truvia™ brand sweeteners marketed by Cargill, Inc., PureVia™ brand sweeteners marketed by Whole Earth Sweetener Company LLC, and NuStevia™ brand sweeteners marketed by NuNaturals, Inc. Stevia-based solutes are particularly suited for use as foam inducing solutes because such solutes assist in generating a lasting foam while simultaneously providing means for sweetening various consumable products in a natural, non-caloric manner. The amount of the stevia-based foam inducing solute may be varied to produce a resulting solution having varying concentrations characterized by different foaming capabilities and sweetness levels.

In some embodiments, heating the stevia-based foam inducing solute and a solvent is required prior to storing the sweetener solution. In other embodiments, the stevia-based foam inducing solute may be completely dissolved in a solvent at room temperature when forming the sweetener solution. In some embodiments, filtering and/or straining may be used to remove undissolved residue from the sweetener solution.

In some embodiments, a method for delivering sweeteners for consumer use includes storing a sweetener solution containing at least a stevia-based foam inducing solute and a sugar substitute or sugar dissolved therein. In this manner, the stevia-based foam inducing agent may be conveniently combined with other commercially available sweetener products to produce a sweetener solution that may be stored and dispensed as a lasting foam.

Foam density and sweetness can be controlled by adjusting the amount of the stevia-based foam inducing agent. For example, when holding other ingredients constant, the sweetness and foam generating capability of the solution is generally reduced as the amount of the stevia-based foam inducing agent is reduced. Thus, to produce a lasting foam having at least mild sweetness, a stevia-based foam inducing solute containing stevia extract (stevia rebaudiana) is dissolved in a solvent to form a sweetener solution having a concentration of at least about 0.07 mass-volume percentage (% m/v) (i.e., 0.07 grams of solute per 100 mL total volume of resulting solution).

From the stored condition, a user may actuate the pump-foamer by depressing a trigger or handle of the pump-foamer to dispense the sweetener solution as a lasting foam. In this manner, a user can selectively sweeten a variety of products to taste by adjusting the number of times the user depresses the handle or trigger (i.e., by ay adjusting the number of pumps) of the pump-foamer. It is also desirable that solutions to be stored for any period of time include a preservative or something that inhibits growth of mold or bacteria.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system for delivering sweeteners, comprising:
a sweetener solution of at least a stevia-based foam inducing solute and a solvent; and
a dispenser configured to dispense the sweetener solution as a lasting foam.

2. The system of claim 1 wherein the sweetener solution includes a sugar substitute dissolved therein.

3. The system of claim 2 wherein the sugar substitute is selected from the group consisting of saccharin, aspartame, sucralose, truvia, purevia and mixtures thereof.

4. The system of claim 1 wherein the sweetener solution includes sugar dissolved therein.

5. The system of claim 1 wherein the sweetener solution includes a bulking agent dissolved therein.

6. A method for delivering sweeteners for consumer use, comprising:
storing a sweetener solution containing at least a stevia-based foam inducing solute dissolved therein in a pump-foamer; and
actuating the pump-foamer to dispense the sweetener solution as a lasting foam.

7. The method of claim 6, wherein storing a sweetener solution containing at least a stevia-based foam inducing solute dissolved therein in a pump-foamer includes storing a sweetener solution containing at least a stevia-based foam inducing solute and a sugar substitute dissolved therein in the pump-foamer.

8. The method of claim 6, wherein storing a sweetener solution containing at least a stevia-based foam inducing solute dissolved therein in a pump-foamer includes storing a sweetener solution containing at least a stevia-based foam inducing solute and sugar dissolved therein in the pump-foamer.

9. The method of claim 6, wherein storing a sweetener solution containing at least a stevia-based foam inducing solute dissolved therein in a pump-foamer includes storing a sweetener solution containing at least a stevia-based foam inducing solute dissolved therein in a pump-foamer such that the sweetener solution has a concentration of the stevia-based foam inducing solute of at least about 0.07% m/v.
